(19) United States
(12) Patent Application Publication
(10) Pub. No.: US 2015/0317924 A1
(43) Pub. Date: Nov. 5, 2015

(54) Unmanned Aerial System for Creating Aerial Message

(71) Applicant: John Chowhan Park, Centreville, VA (US)

(72) Inventor: John Chowhan Park, Centreville, VA (US)

(21) Appl. No.: 14/268,232

(22) Filed: May 2, 2014

(51) Int. Cl. G09F 21/16; G05D 1/00; B64C 39/02

(52) U.S. Cl. CPC G09F 21/16; B64C 39/024; G05D 1/0088

(57) ABSTRACT

An unmanned aerial vehicle (UAV) for creating aerial message. Upon user's inputting a message, character, image, shape, or pattern that the user desires to skywrite into a computer, an UAV attached with smoke/vapor generator automatically pilot itself to skywrites the message, character, image, shape or pattern with smoke or vapor trails in a location specified by the user. The UAV for creating aerial message comprises of an UAV, a smoke/vapor generator, UAV control unit, and computer.

### FIELD

The present invention relates to unmanned aerial vehicles (UAV), and more specifically to UAVs capable of creating aerial message using smoke or vapor trail.

### BACKGROUND

Skywriting is the process of using an aircraft, able to expel special smoke during flight, to fly in certain patterns to create writing readable by someone on the ground. The message can be a frivolous or generally meaningless greeting or phrase, an advertisement aimed at everyone in the vicinity, a general public display of celebration or goodwill, or a personal message such as a marriage proposal or birthday wish.

“UAV” is an acronym for Unmanned Aerial Vehicle, which is an aircraft with no pilot on board. UAVs can be remotely controlled aircraft (e.g. flown by a pilot at a ground control station) or aircraft that can fly autonomously based on preprogrammed flight plans or more complex dynamic automation systems. UAVs are currently used for a number of missions, including reconnaissance and attack roles.

Traditionally, skywriting or skytyping has been performed by a human pilot flying an aircraft capable of generating a smoke trail or by a human controller flying remote-controlled aircraft directly controlled by a human controller. This involves cost of flying the aircraft and hiring a pilot. Furthermore, since the skywriting is performed by a human pilot, the skywritten messages are not accurate and precise.

### SUMMARY

The present invention relates to an unmanned aerial vehicle (UAV) for creating aerial message. Upon user's inputting a message, character, image, shape, or pattern that the user desires to skywrite into a computer, a UAV attached with smoke/vapor generator automatically pilot itself to skywrite the message, character, image, shape or pattern with smoke or vapor trails in a location specified by the user. The UAV for creating aerial message comprises a UAV, a smoke/vapor generator, a UAV control unit, and a computer. A UAV, colloquially known as a drone, is an aircraft without a human pilot onboard. Its flight is controlled either autonomously by computers in the vehicle or under the remote control of a pilot on the ground or in another vehicle. A user will input the message, character, image, shape, or pattern she desires to skywrite into computer. The user may draw, type, or select a message, character, image, shape, or pattern in the computer. The user may further input location information where the skywriting would take place. The location information includes at least one of GPS information, coordinates, distance from the base station, etc. Consequently, the computer will calculate Flight information and Emission Control Information using inputs provided by the user. The Flight Information is information that determines when and where to fly the UAV in order to skywrite the message, character, image, shape, or pattern. The Flight Information determines an optimal flight path and an optimal control maneuver of the UAV. The Flight Information includes at least one of GPS information, path planning information, trajectory generation information, flight path information, itinerary information, velocity, acceleration, timing interval, and time of travel. Path is an ordered sequence of manipulator configurations and trajectory is a path with specified timing requirements. Path planning information determines an optimal path for the vehicle to go while meeting certain objectives. Trajectory generation information determines an optimal control maneuver to take to follow a given path or to go from one location to another with specified timing requirement. The Flight information may further include any information necessary to pilot the UAV. The Emission Control Information is the information that determines when and where to emit smoke or vapor trail. Emission Control Information includes at least one of emission time information, emission duration information, emission sequence, and location information. The computer transmits the Flight Information and Emission Control Information to the UAV control unit. The UAV control unit pilots the UAV according to the Flight Information. The UAV control unit controls direction, velocity, and acceleration of the UAV. The UAV control unit controls smoke/vapor generator to emit smoke or vapor trail according to Emission Control Information. The UAV control unit may be directly implemented on the UAV, or it may be implemented on the base station and transmit control instruction wirelessly to the UAV. Smoke/vapor generator is a device that generates smoke or vapors to be expelled into the sky to create smoke or vapor trail or puffs visible on the ground. The smoke or vapor may be generated in a variety of ways including injecting of oil into exhaust or hot plate, spraying chemical, and vaporizing chemical. The smoke/vapor generator may emit colored smoke or vapor trail. The user may select color of smoke or vapor trail on the computer. The smoke/vapor generator may generate a luminous trail that is visible in the dark. The present invention is not limited to use a single UAV for creating aerial messages. The user may use one or more UAVs to create aerial messages. Creating aerial message includes skywriting and skytyping.

### BRIEF DESCRIPTION OF THE DRAWINGS

FIG. 1 illustrates an UAV creating aerial message.

FIG. 2 Illustrates explanatory diagram regarding skywriting a rectangle.

FIG. 3 Illustrates a perspective view, as seen from the ground, of a rectangular shaped aerial message created by the UAV creating aerial message.

FIG. 4 Illustrates an explanatory diagram regarding skywriting the alphabet character “A.”

FIG. 5. Illustrates a perspective view, as seen from the ground, of the alphabet character “A” aerial message created by the UAV creating aerial message.

### DETAILED DESCRIPTION

In the following description, numerous specific details are set forth in order to provide a thorough understanding of the present invention. The present invention may be practiced without some or all of these specific details. In other instances, well known process operations have not been described in detail to not unnecessarily obscure the present invention. While the invention will be described in conjunction with the specific implementations, it will be understood that it is not intended to limit the invention to the implementations.

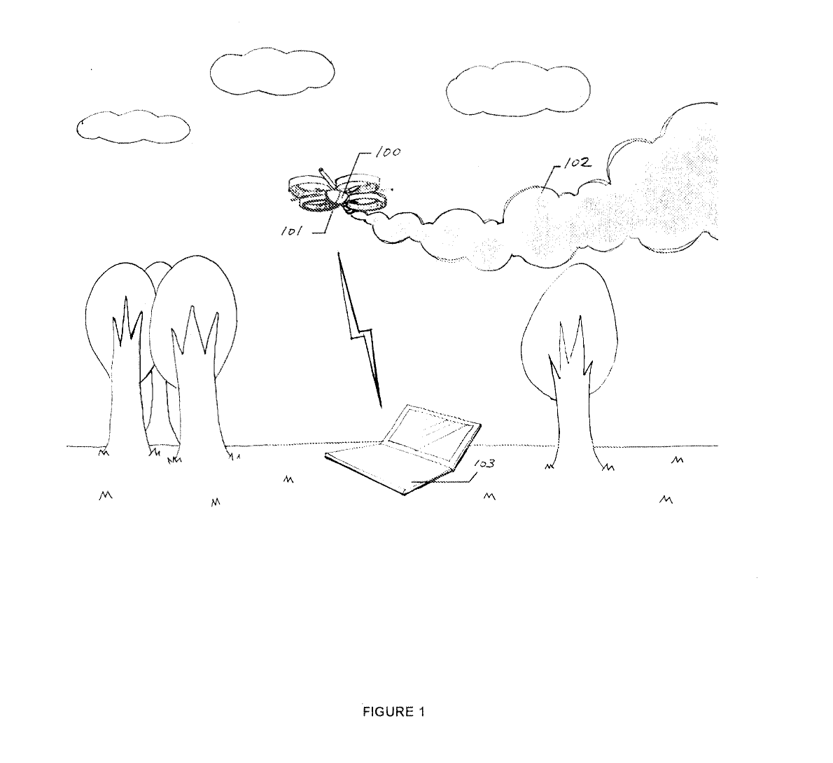

FIG. 1 illustrates a UAV creating an aerial message. Referring to FIG. 1, a UAV 100 attached with a smoke/vapor generator 101 automatically pilots itself to skywrite the message, character, image, shape or pattern with smoke or vapor trails 102 when user has input the message, character, image, shape, or pattern that the user desires to skywrite into a computer 103.

The UAV for creating aerial message comprises of an UAV 100, a smoke/vapor generator 101, an UAV control unit, and a computer 103. An UAV 100, colloquially known as a drone, is an aircraft without a human pilot onboard. Its flight is controlled either autonomously by computers in the vehicle or under the remote control of a pilot on the ground or in another vehicle.

The computer 103 may be located in the base station. The computer 103 may be located in the airplane so the pilot of the airplane may control the UAV creating aerial message.

A user will input a message, character, image, shape, or pattern she desires to skywrite into computer 103. The user may draw, type, or select a message, character, image, shape, or pattern on computer 103. The user may further input location information where the skywriting would take place.

The smoke/vapor generator 101 is a device that generates smoke or vapors to be expelled into the sky to create smoke or vapor trails or puffs visible on the ground. The smoke or vapor may be generated in a variety of ways including injecting of oil into exhaust or hot plate, spraying chemical, and vaporizing chemical. The smoke/vapor generator may emit colored smoke or vapor trail. The user may select the color of smoke or vapor trail on the computer. The smoke/vapor generator may generate luminous trail that is visible in the dark.

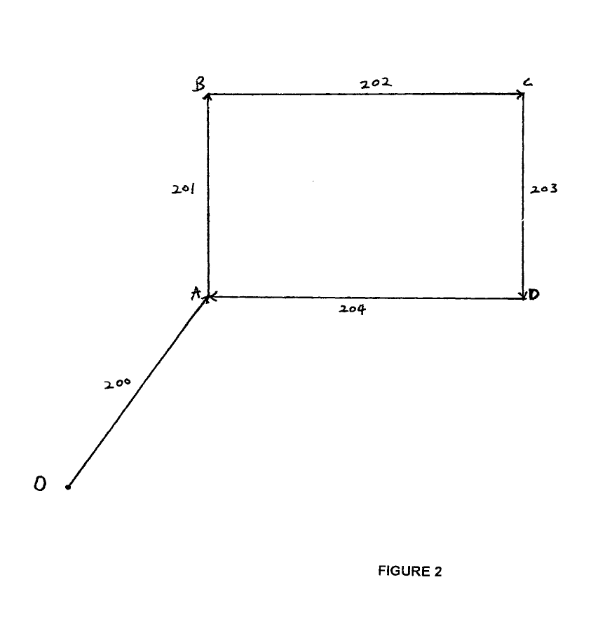

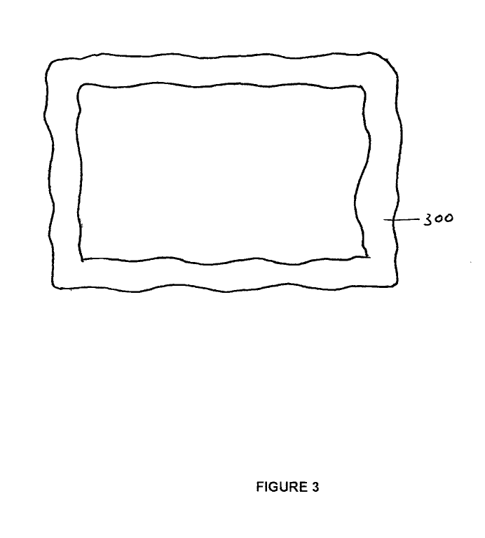

FIG. 2 Illustrates an explanatory diagram regarding skywriting a rectangle and FIG. 3. Illustrates a perspective view, as seen from the ground, of a rectangular shaped aerial message created by the UAV creating aerial message. In this embodiment, a user desires to skywrite rectangular shape in the sky. The user will draw rectangle on the computer or select a rectangle among predetermined geometrical figures. The user further inputs location where rectangular shaped aerial message to be drawn.

The computer will calculate Flight Information and Emission Control Information using inputs provided by the user. The Flight Information is information that determines when and where to fly the UAV in order to skywrite the message, character, image, shape, or pattern. The Flight Information determines an optimal flight path and an optimal control maneuver of the UAV. The Flight Information includes at least one of GPS information, path planning information, trajectory generation information, flight path information, itinerary information, velocity, acceleration, timing interval, and time of travel. Path is an ordered sequence of manipulator configurations and trajectory is a path with specified timing requirements. Path planning information determines an optimal path for the vehicle to go while meeting certain objectives. Trajectory generation information determines an optimal control maneuver to take to follow a given path or to go from one location to another with specified timing requirement. The Flight Information may further include any information necessary to pilot the UAV.

In this embodiment, the computer calculates the Flight Information for skywriting rectangular shape according to FIG. 2. The Flight Information includes initial point (point 0) to point A (Path Segment 1) 200, point A to Point B (Path Segment 2) 201, point B to point C (Path Segment 3) 202, point C to point D (Path Segment 4) 203, and point D to point A (Path Segment 5) 204.

In this embodiment, points 0, A, B, C, and D represents Cartesian coordinates since the multidimensional space is typically represented by Cartesian coordinates of x, y, and z directions with the x and y axes defining a horizontally oriented plane throughout the multidimensional space and the z axis representing an azimuthal direction which is perpendicular to the x, y plane. It is obvious that other coordinate systems can be used to represent the multidimensional space. For the purpose of simplicity of description, the Cartesian coordinate system is used herein.

The computer further calculates Emission Control Information to plan when to emit the smoke/vapor trail. The Emission Control Information is the information that determines when and where to emit the smoke or vapor trail. Emission Control Information includes at least one of emission time information, emission duration information, emission sequence, and location information.

In this embodiment, the smoke or vapor trail will not be release during Path Segment 1 200 since the UAV has to move to point A without releasing any trail. The computer further plans to emit smoke/vapor trail while UAV is flying the Path Segment 2 201, Path Segment 3 202, Path Segment 4 203, and Path Segment 5 204 in order to skywrite a rectangle.

The computer transmits the Flight Information and Emission Control Information to the UAV control unit. The UAV control unit controls direction, velocity, and acceleration of the UAV. The UAV control unit controls the smoke/vapor generator to emit smoke or vapor trail according to Emission Control Information. The UAV control unit may be directly implemented on the UAV, or it may be implemented on the base station and transmit control instruction wirelessly to the UAV.

In this embodiment, the UAV controller unit will pilot the movement of the UAV and control emission of the vapor/smoke generator to skywrite a rectangular FIG. 300 as shown in FIG. 3.

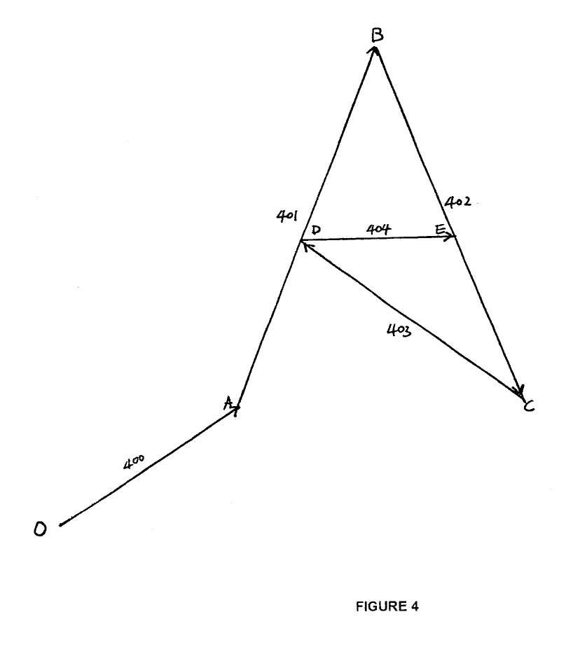

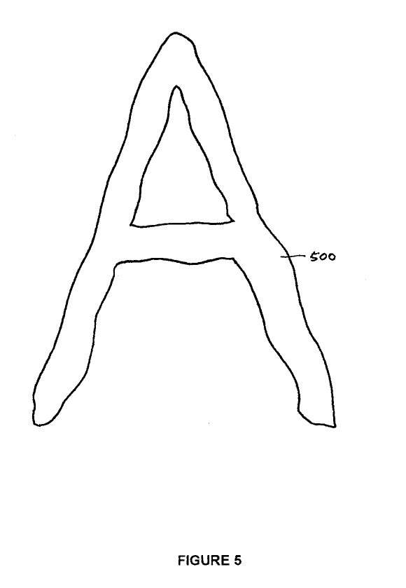

FIG. 4 Illustrates explanatory diagram regarding skywriting the alphabet letter “A,” and FIG. 5 Illustrates a perspective view, as seen from the ground, of the alphabet letter “A” aerial message created by the UAV creating aerial message.

In this embodiment, a user desires to skywrite the alphabet letter “A” in the sky. The user will draw the alphabet “A” on the computer or select the alphabet letter “A” among predetermined alphabets or letters. The user further inputs location where the alphabet letter “A” aerial message to be drawn.

The computer will calculate Flight information and Emission Control Information using inputs provided by the user. The Flight Information is information that determines when and where to fly the UAV in order to skywrite the message, character, image, shape, or pattern. The Flight Information determines an optimal flight path and an optimal control maneuver of the UAV. The Flight Information includes at least one of GPS information, path planning information, trajectory generation information, flight path information, itinerary information, velocity, acceleration, timing interval, and time of travel. Path is an ordered sequence of manipulator configurations and trajectory is a path with specified timing requirements. Path planning information determines an optimal path for the vehicle to go while meeting certain objectives. Trajectory generation information determines an optimal control maneuver to take to follow a given path or to go from one location to another with specified timing requirement. The Flight information may further include any information necessary to pilot the UAV.

In this embodiment, the computer calculates the Flight Information for skywriting the alphabet letter “A” according to FIG. 4. The Flight Information includes initial point (point 0) to point A (Path Segment 1) 400, point A to Point B (Path Segment 2) 401, point B to point C (Path Segment 3) 402, point C to point D (Path Segment 4) 403, and point D to point E (Path Segment 5) 404.

In this embodiment, points 0, A, B, C, D, and E represents Cartesian coordinates since the multidimensional space is typically represented by Cartesian coordinates of x, y, and z directions with the x and y axes defining a horizontally oriented plane throughout the multidimensional space and the z axis representing an azimuthal direction which is perpendicular to the x, y plane. It is obvious that other coordinate systems can be used to represent the multidimensional space. For the purpose of simplicity of description, the Cartesian coordinate system is used herein.

The computer further calculates Emission Control Information to plan when to emit the smoke/vapor trail or puff. The Emission Control Information is the information that determines when and where to emit smoke or vapor trail. Emission Control Information includes at least one of emission time information, emission duration information, emission sequence, and location information.

In this embodiment, smoke vapor trail will not be release during Path Segment 1 200 since the UAV has to move to point A without releasing any smoke or vapor trail. The computer further plans to emit smoke or vapor trail while UAV is flying the Path Segment 2 401 and Path Segment 3 402 in order to skywrite A shape. During flying the Path Segment 4 403, smoke or vapor trail will not be released and then after reaching point D, the smoke/vapor trail will be emitted again for flying the Path Segment 5 404.

The computer transmits the Flight Information and Emission Control Information to the UAV control unit. The UAV control unit controls direction, velocity, and acceleration of the UAV. The UAV control unit controls smoke/vapor generator to emit smoke or vapor trail according to Emission Control Information. The UAV control unit may be directly implemented on the UAV, or it may be implemented on the base station and transmit control instruction wirelessly to the UAV.

In this embodiment, the UAV controller unit will pilot the movement of UAV and control emission of vapor/smoke generator to skywrite alphabet “A” shaped smoke or vapor trail 500 as shown in FIG. 5.

What claimed is:

1. An unmanned aerial vehicle (UAV) for creating aerial message comprising:
an unmanned aerial vehicle;
a smoke/vapor generator that emits smoke/vapor trail or puff;
an UAV control unit that controls movements of UAV according to Flight Information and controls emission of smoke/vapor trail or puff according to Emission Control Information; and
a computer that processes inputs from a user to compute Flight Information and Emission Control Information;
wherein the computer is configured to receive a user-input message, character, image, shape,
or pattern desired to be skywrite.

2. An unmanned aerial vehicle (UAV) for creating aerial message of claim 1, wherein the computer is configured to receive user-input location information where the UAV skywrites a message, character, image, shape, or pattern.

3. An unmanned aerial vehicle (UAV) for creating aerial message of claim 1, wherein Flight Information is data that determine an optimal flight path and an optimal control maneuver of UAV.

4. An unmanned aerial vehicle (UAV) for creating aerial message of claim 1, wherein Flight Information includes at least one of GPS information, path planning information, trajectory generation information, flight path information, itinerary information, velocity, acceleration, timing interval, and time of travel.

5. An unmanned aerial vehicle (UAV) for creating aerial message of claim 1, wherein Emission Control Information is data that determine when and where to emit smoke/vapor trail or puff.

6. An unmanned aerial vehicle (UAV) for creating aerial message of claim 1, wherein Emission Control Information includes at least one of emission planning information, emission time information, emission duration information, emission sequence, timing interval, and location information.

7. An unmanned aerial vehicle (UAV) for creating aerial message of claim 1, wherein a color of smoke/vapor trail or puff is selected by a user.

8. An unmanned aerial vehicle (UAV) for creating aerial message of claim 1, wherein smoke/vapor trail or puff is luminous trail or puff.

9. A method for creating aerial message using an unmanned aerial vehicle comprising: inputting a message, character, image, shape, or pattern into a computer by a user;
processing the inputs from the user to compute Flight Information and Emission Control Information with computer; and
controlling, with an UAV control unit, movements of UAV according to Flight Information and controlling, with the UAV control unit, a smoke/vapor trail or puff emission according to Emission Control Information.

10. A method for creating aerial message using an unmanned aerial vehicle (UAV) for creating aerial message of claim 9, further comprising:
inputting location information where the UAV skywrites pattern, image, shape, message or character into a computer by a user.

11. A method for creating aerial message using an unmanned aerial vehicle (UAV) for creating aerial message of claim 9, wherein Flight Information is data that determine an optimal flight path and an optimal control maneuver of UAV.

12. A method for creating aerial message using an unmanned aerial vehicle (UAV) for creating aerial message of claim 9, wherein Flight Information includes at least one of GPS information, flight path information, itinerary information, velocity, acceleration, time of travel.

13. A method for creating aerial message using an unmanned aerial vehicle (UAV) for creating aerial message of claim 9, wherein Emission Control Information is data that determine when and where to emit smoke/vapor trail puff.

14. A method for creating aerial message using an unmanned aerial vehicle (UAV) for creating aerial message of claim 9, further comprising:
selecting the color of smoke/vapor trail or puff by a user.
